(19) United States
(12) Patent Application Publication
(10) Pub. No.: US 2005/0119959 A1
(43) Pub. Date: Jun. 2, 2005

(54) Project optimization system

(76) Inventor: Jeffrey Scott Eder, Mill Creek, WA (US)

Correspondence Address: JEFF EDER, 19108 30TH DRIVE SE, MILL CREEK, WA, 98012, US

(21) Appl. No.: 10/012,375

(22) Filed: Dec. 12, 2001

(51) Int. Cl. G06F 17/60

(52) U.S. Cl. 705/36

(57) ABSTRACT

An automated system (100) and method for optimizing project risk and return from the perspective of the sponsor. The project, project features and feature options are defined using project design system and project financial system data. The expected project outputs are then mapped to matrices of value and risk for the sponsor. The system calculates a value for the project then identifies the mix of features and feature options that maximize expected project value from the perspective of the sponsor. The system also identifies the mix of features and feature options that maximize expected project value while minimizing project risk from other frames.

### CROSS REFERENCE TO RELATED APPLICATIONS AND PATENTS

The subject matter of this application is related to the subject matter of application Ser. No. 09/994,720 filed Nov. 28, 2001, application Ser. No. 09/994,739 filed Nov. 28, 2001, application Ser. No. 09/931,422 filed Aug. 17, 2001, U.S. Pat. No. 5,615,109 for “Method of and System for Generating Feasible, Profit Maximizing Requisition Sets”, by Jeff S. Eder an U.S. Pat. No. 6,321,205 “Method of and System for Modeling and Analyzing Business Improvement Programs” by Jeff S. Eder, the disclosure of which is incorporated herein by reference.

### BACKGROUND OF THE INVENTION

This invention relates to a computer based method of and system for optimizing projects in a manner that maximizes expected returns while minimizing risk for the enterprise or multi-enterprise organization that sponsors the project.

All design projects have goals for profitability and expected financial return. Success in meeting these goals is a function of many things including the choices the project team makes as they work to complete the design. For example, a team designing a building could choose to install hard wood floors, or it could choose to spend the same money installing more energy-efficient air conditioning. The system of the present invention optimizes those choices in a way that enhances project value while minimizing risk for the enterprise or organization that sponsored the project (optimization=maximum value, minimum risk).

The way in which projects are designed has an enormous influence on the economy of the United States and the world. For example, buildings consume over 30% of the global energy resources and they typically last for over 40 years. Automobiles consume an even larger part of the primary global energy resources and while they typically last less than ten years, many of the systems and components in the cars are used for several generations of cars. As a result, the decisions the engineers and architects make today about the best design for components and systems within buildings and cars will have an enormous impact on global energy demand for the foreseeable future. Over 40 years the efficiency of most systems within the cars and buildings will improve dramatically, prices for commodities like oil and electricity will probably increase markedly, the car and building owners will experience many different business cycles, and the needs of these owners will evolve as technology and business practices advance. Generalizing from the specific instance of cars and buildings we can see that optimizing the choices made today for a project that will last 40 years is not an easy task.

Unfortunately, the traditional practice in for many project developers is to ignore the medium and long-term ramifications of their design decisions and focus only on investments that provide a payback within 3 or 5 years. One reason for this short-term focus is that there are no tools to assist engineers, architects and designers in analyzing the impact of uncertainty and long term price trends on their optimal design decisions. It is worth noting here that there are no known systems that assist engineers, architects and designers to:
1. analyze the tradeoffs between risk and return for the projects they are designing;
2. understand the implications of the risks created by volatility and uncertainty surrounding commodity prices for the projects they are creating;
3. evaluate the impact of the projects they are developing on the public infrastructure and the environment;
4. optimize their design to maximize project value while minimizing project risk (AKA the efficient frontier) from the project perspective; and/or
5. optimize their design to maximize project value while minimizing project risk from the perspective of the project sponsor.

It is worth noting at this point that simple portfolio analysis and optimization systems are available. These systems help users select the best combination of projects, given the funds available for project development and the expected risk and return for the each of the separate projects. Unfortunately, these systems fail to address any aspects of the project design that could improve value as they generally take the project value and risk to be givens. They also fail to address the impact of the project on value and risk at the enterprise or multi-enterprise organization sponsoring the project.

All known project management systems also fail to address:
1. the five different ways in which business value can be created for an enterprise (providing products or services that generate cash, holding income producing financial assets, holding derivatives, creating real options for generating cash and market sentiment);
2. the six different types of enterprise risk (risks associated with the 5 business value creation methods plus event risk);
3. the inter-relationship between value and risk; and/or
4. the complex inter-relationships between project features and enterprise elements of value, segments of value and/or external factors.

The importance of analyzing these different factors will vary by project, enterprise and organization. However, in aggregate they can alter the economics of a project in such a way that the best set of project features when enterprise or organization value and risk are optimized will be different than the “optimal” set of features for the stand-alone project. In a similar manner, the best combination of projects from the enterprise or organization perspective may be very different than the best combination of projects selected by a portfolio analysis that takes the value and risk of each project as an independent factor. The enterprises and organizations sponsoring the projects are, of course, interested in optimizing their own financial performance so the utility of project analysis applications that don't consider this perspective is questionable at best.

In light of the preceding discussion, it is clear that it would be desirable to have an automated system that optimized the expected risk and return to an enterprise or organization from projects it was sponsoring. Ideally, this system would be capable of optimizing a wide variety of projects.

### SUMMARY OF THE INVENTION

It is a general object of the present invention to provide a novel and useful system that calculates and displays the list of the project features and attributes that maximize expected value while minimizing risk for the enterprise or multi-enterprise organization sponsoring the project that overcome the limitations and drawbacks of the prior art that were described previously.

A preferable object to which the present invention is applied is the analysis of a project where a significant portion of the project value is determined by the choice of features that will be included in the initial construction.

The economics associated with projects are reasonably straightforward. The income the project sponsor receives from the project deliverables needs to exceed the cost of developing and operating the project if the project is to be successful. These factors are summarized in Equation 1 below.
Financial Return Equation: Deliverables Income>Design Cost+Development Cost+Financing Cost+Building Cost+Operating Cost+Selling Cost (optional) Equation 1

The level of profitability for the project is determined by how much the total Deliverables Income exceeds the total of the five or six cost elements. As discussed later, the value of the project is determined by the timing of the different cash flows and the risk associated with the cash flows. The profitability required to adequately compensate investors for the level of risk they assume when financing development varies by the type of project.

Taking a broader perspective, Equation 1 (the Financial Return Equation) would be modified as shown below in Equation 2 to capture the cost of environmental impacts and public infrastructure impacts—collectively referred to as “externalities”—that are not normally charged directly to a design and development project. These costs are particularly relevant to development projects
Financial Return Equation: Deliverables Income>Design Cost+Development Cost+Financing Cost+Building Cost+Operating Cost+Environmental Cost+Public Infrastructure Cost+Selling Cost (optional) Equation 2

We will use Equation 1 as the basis for the economic analysis framework at the project level except for specific instances where there are public-private partnerships in place to develop a project. The multi-enterprise organization structure defined in cross-referenced application Ser. No. 11/111,112 enables us to in effect use equation 2 when one of the “enterprises” within the organization is a public organization.

We have already identified the fact that the framework for optimizing a development project will have to analyze all seven (or nine) elements of the Financial Return Equation. Completing the framework for optimizing the risk and return for a development project from the enterprise or organization perspective requires us to consider three more factors:
1) the frame that should be used for evaluating project tradeoffs;
2) the way flexibility produces economic sustainability; and
3) the impact of soft benefits on project economics.
   After the impacts of these three factors are reviewed, we will illustrate the application of the enterprise and/or multi-enterprise organization framework to analyzing design and development project.

Many design and development projects exist within the context of something larger than the project itself. For example, starting at the lowest level and working higher, a component design:
a) could be developed for a single product;
b) could be developed for a family of products;
c) could be developed for all products within a company
   To further illustrate the point, starting at the lowest level and working higher, a building system design:
a) could be developed for a single building;
b) could be developed for a cluster of buildings;
c) could be developed for a company wide development project

Optimizing project design tradeoffs from the appropriate perspective (hereinafter, frame) is a critical first step. There are two aspects to selecting the proper frame; first the full scope of the project should be determined. As the two prior examples illustrate, the analyses should start at the full project scope level and move down. The results of each analysis at each level or frame needs to be passed down to the level(s) below for inclusion. If present, incentive and/or penalty programs from government agencies should also be examined at each frame they apply and the results passed down to the level(s) below. The second aspect of determining the proper frame is deciding the economic entity that will be optimized. Using the first set of examples, we could optimize from a product frame, a product family frame or a company frame.

The system of the present invention is the first known system with the ability to optimize project design from the enterprise or multi-enterprise organization frame.

After the proper frames have been chosen, the project needs to be analyzed for the impact flexibility will have on project economics. As discussed previously, many projects can have useful lives of several decades. As mentioned previously, a commercial building typically lasts 40 years. One of the best ways to maximize the return of a commercial building project is to ensure that it is fully and productively utilized over that time period (or even longer). This is not as easy as it sounds. Over a 40 year period: the efficiency of most building systems will improve dramatically, prices for utilities will probably increase markedly, the facility's occupants will experience many different business cycles, and the needs of these occupants will evolve as technology and business practices advance. Thus, we can see that one of the keys to a long life for a commercial building is the flexibility to adapt to these changing conditions over time. In fact, flexibility can add value to almost any project design.

Fortunately, we now have tools such as real option analysis that allow us to evaluate the flexibility that is designed in to a project. For the purposes of our discussion, we will define flexibility as the ability to respond to changing economic conditions. This type of flexibility has two financial impacts. First, giving the project the ability to adapt to changing conditions reduces the risk associated with investing in the project. The same flexibility also increases the expected life, income and value of the project. In short, adding flexibility can create economic sustainability. The value of flexibility is directly related to the amount of uncertainty surrounding the factor(s) that are volatile and/or increasing in price. For example, if the price of butter was growing steadily and it routinely fluctuated by 50% or more every month, then the flexibility to switch to margarine would be very valuable to a business that used a large amount of butter. Alternatively, if the price of butter were stable or declining, then the flexibility to switch to margarine would probably not be worth much.

For many projects, a large part of the uncertainty surrounds prices for commodities like electricity, metals and water that are increasingly scarce and have a number of related environmental impacts. As a result, the value of the flexibility to use alternative sources for these commodities is relatively high. Examples of adding project flexibility to switch to a alternative solution could include: providing the infrastructure required to enable a rapid photovoltaic retrofit for a commercial building, providing for an alternative alloy for an automobile part and providing for the later installation of on-site co-generation for a hospital. We can now modify the Financial Return Equation as shown in Equation 3 to explicitly account for the value of flexibility.
Financial Return Equation: Value of Flexibility+Deliverables Income>Design Cost+Development Cost+Financing Cost+Selling Cost+Building Cost+Operating Cost (optional)+Environmental Cost+Public Infrastructure Cost Equation 3

The flexibility to add features to the project is valued using real option pricing algorithms. Real option pricing algorithms are improvements over traditional methods as they correct two inaccurate assumptions implicit in traditional discounted cash flow analyses of business growth opportunities, namely: the assumption that investment decisions are reversible, and the assumption that investment decisions can not be delayed. In reality, a firm with a project that requires an investment has the right but not the obligation to buy an asset at some future time of its choosing. However, once the investment is made it is often irreversible—a situation analogous to a call option. Because real option valuation algorithms explicitly recognize that investments of this type are often irreversible and that they can be delayed, the asset values calculated using these algorithms are more accurate than valuations created using more traditional approaches. The use of real option pricing analysis for project feature flexibility gives the present invention a distinct advantage over traditional approaches to financial analysis.

The framework for analysis outlined above already has the ability to capture many of the “soft benefits” that different choices made about what features to include in the project are expected to generate. Using the prior example within the framework of Equation 1 the project team:
1. could choose to have a marble floor,
2. could choose to spend the same money installing more energy efficient air conditioning, or it
3. could choose to install both a marble floor and more energy efficient air conditioning because the benefit of having both is expected to increase income enough to offset the increased cost.
   Using the framework of Equation 2, some of the environmental benefits that different project features generate can also be captured by using a multi-enterprise organization to represent the private-public partnership. Using the framework of Equation 3, the flexibility to switch to more energy efficient air-conditioning at a later date can also be evaluated. As detailed later, the “soft” benefits of the project to the sponsor can be further quantified by mapping the expected project outputs to the matrices of value and risk for the sponsor.

In addition to analyzing potential economic benefits associated with a project, the overall risk profile should also be evaluated. All projects face a number of risks. The seven risks most commonly associated with projects and their risk matrix classifications are shown below in Table 1.

TABLE 1

| Project Risks (classification) | | Description |
|---|---|---|
| 1. | Economic Risk (external | Economic conditions affect |
| | factor variability risk) | the ability to derive income |
| | | from the project, this risk |
| | | is also a function of the |
| | | amount of leverage used |
| 2. | Weather (external factor | The ability to complete and |
| | both variability and event risk) | operate a project may be |
| | | dependent on the weather |
| 3. | Inflation Risk (external | Unexpected inflation can |
| | factor variability risk) | reduce the income from the |
| | | project this would include |
| | | commodity risks |
| 4. | Interest Rate Risk (external | Changes in interest rates |
| | factor variability risk) | can affect the value of a |
| | | project |
| 5. | Operation Risk (element | Effective operation of the |
| | variability risk) | project is often required to |
| | | maximize project returns |
| 6. | Legislative Risk (event risk) | Regulations may affect the |
| | | economic value of a project |
| 7. | Environmental Risk (event risk) | Projects are often affected |
| | | by changes in the environment |
| | | or new awareness of hazards |
| | | that exist in the environment |

The risk associated with the project has a direct relationship to the cost of capital for the project. Therefore, reducing risk can directly increase value. Reducing the level of risk can also have an impact on the income produced by the project by reducing the need for and/or the cost of insurance.

Summarizing the preceding discussion, project features can have an impact on up to ten elements of the Financial Return Equation (equation 3) and at least seven different types of risk. As detailed in the following sections, the information regarding these features and risks can be analyzed to identify and display the efficient frontier for project design on a stand-alone basis.

When this same information is combined the matrices of value and risk for the enterprise or multi-enterprise organization sponsoring the project (see application Ser. No. 09/994,720 filed Nov. 28, 2001 and application Ser. No. 09/994,739 filed Nov. 28, 2001 for details), then the efficient frontier for the project or projects from the sponsors frame can also be identified and displayed.

Before going further, we need to define more carefully the term's project, feature and sponsor. A project is an activity or a collection of activities that are initiated and completed over a finite time period as required to produce a deliverable. The project deliverable can have an expected life that is limited to a fraction a second, indefinite or anything in between these two extremes. Every project has requirements and features. Requirements are processes that must be used or identifiable aspects of the deliverable. Features include all the different options the project manager has for meeting a requirement. For example, a computer software project has a requirement that one language be used for writing the code. Java, C++ and Visual Basic are examples of features that could be used to satisfy this requirement. Another example would be a building that requires a floor. Concrete, wood, brick and carpet are examples of features that could be used to satisfy this requirement. During the expected life of the project deliverable, the deliverable provides an output or outputs that are expected to benefit the project sponsor. For our purposes, the project sponsor will be the enterprise or multi-enterprise organization that is expected to benefit from the deliverable output. In some cases, the project sponsor may not be the enterprise or organization paying for the project. It should also be noted at this point that the system of the present invention can be used to optimize the project design from other frames in addition to the two (standalone and sponsor perspective) we have focused on.

Analyzing the project from the frame of the project sponsor requires mapping the project outputs to the matrix of value and the matrix of risk for the project sponsor before optimizing the project feature selection. FIG. 7 illustrates how the output from a co-generation project would be mapped to the matrices of value and risk for the project sponsor. The cogeneration project outputs would be low cost electricity, low cost heating in the winter and low cost cooling in the summer. These outputs would be mapped to the sponsor by:
1) creating a new element of value for the cogeneration project—to the extent the electricity, heating and cooling are now obtained at prices lower than the baseline price (price before plant was installed) the sponsor has a new element of value;
2) linking costs for operating the new element of value to the current operation segment of value and real options that will depend on the cogeneration plant as shown in FIG. 7;
3) linking reduced expenses for electricity and for heating/cooling to the corresponding external factors in the current operation, derivative and real option segments of value,
4) linking increased risk associated with the operating the new plant to the current operation and real option segments of value,
5) linking reduced risk for electricity and heating and cooling expenses to the corresponding external factors in the current operation, real options and derivatives segments of value.

Once the project outputs are mapped to the matrices of value and risk for the project sponsor, the project can be optimized from the frame of the project sponsor.

In accordance with the invention, the automated extraction, aggregation, analysis and optimization of commodity and project feature data from a variety of existing computer-based systems significantly increases the scale and scope of the analyses that can be completed by users without a significant background in finance. To facilitate its use as a tool for improving the value of a project, the system of the present invention produces reports in formats that are graphical and highly intuitive. This capability gives architects, engineers and designers the tools they need to dramatically improve the long-term financial performance of the projects they design and develop for the project sponsors.

### BRIEF DESCRIPTION OF DRAWINGS

These and other objects, features and advantages of the present invention will be more readily apparent from the following description of the preferred embodiment of the invention in which:

FIG. 1 is a block diagram showing the major processing steps of the present invention;

FIG. 2 is a diagram showing the files or tables in the application database of the present invention that are utilized for data storage and retrieval during the processing in the system for project risk and return management;

FIG. 3 is a block diagram of an implementation of the present invention;

FIG. 4 is a diagram showing the data windows that are used for receiving information from and transmitting information to the user during system processing;

FIG. 5A, FIGS. 5B and 5C are block diagrams showing the sequence of steps in the present invention used for extracting, aggregating and storing information utilized in system processing from: user input, the design system database, the operating factors database, the project financial database, optionally, the simulation program database; the internet; and the Sponsor Value Map® System database;

FIGS. 6A and FIG. 6B are block diagrams showing the sequence of steps in the present invention that are utilized in identifying the project configuration that maximizes expected returns and value while minimizing risk for the enterprise or multi-enterprise organization;

FIG. 7 is a diagram illustrating how the expected project outputs are mapped to the matrices of value and risk for the project sponsor; and

FIG. 8 is a block diagram showing the sequence of steps in the present invention used for selecting, optionally displaying and optionally printing management reports.

### DETAILED DESCRIPTION OF THE PREFERRED EMBODIMENT

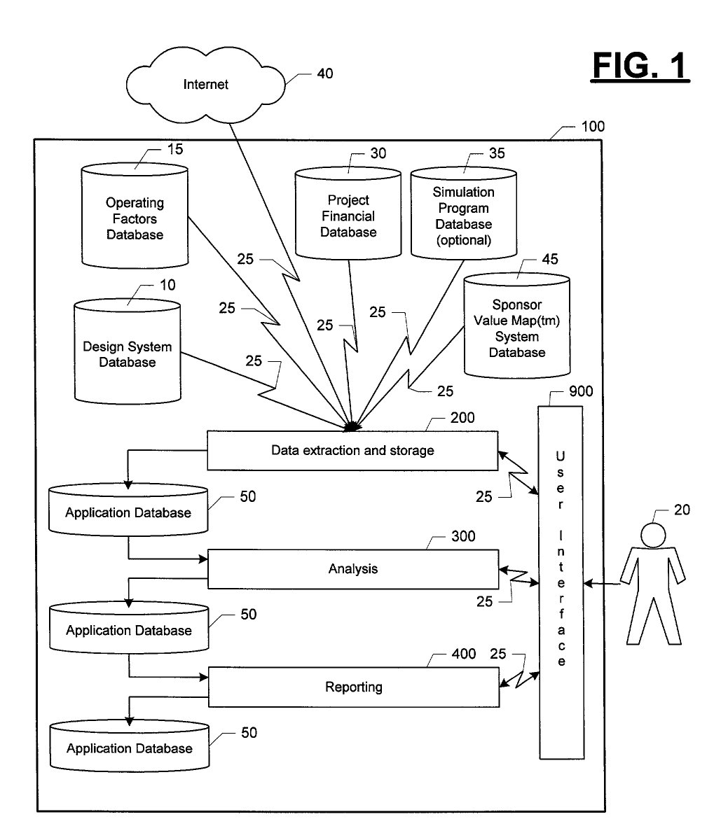

FIG. 1 provides an overview of the processing completed by the innovative system for project risk and return optimization. In accordance with the present invention, an automated method of and system (100) for project risk and return optimization is provided. Processing starts in this system (100) with a block of software (200) that extracts, aggregates and stores the data and user input required for completing the analysis. This information is extracted via a network (25) from a design system database (10), an operating factors database (15), a project financial system database (30), optionally, a simulation program database (35), the Internet (40) and a Sponsor Value Map® System database (45). These information extractions and aggregations are guided by a user (20) through interaction with a user-interface portion of the application software (900) that mediates the display and transmission of all information to the user (20) from the system (100) as well as the receipt of information into the system (100) from the user (20) using a variety of data windows tailored to the specific information being requested or displayed in a manner that is well known. While only one database of each type (10, 15, 30, 35 & 45) is shown in FIG. 1, it is to be understood that the system (100) can extract data from multiple databases of each type via the network (25).

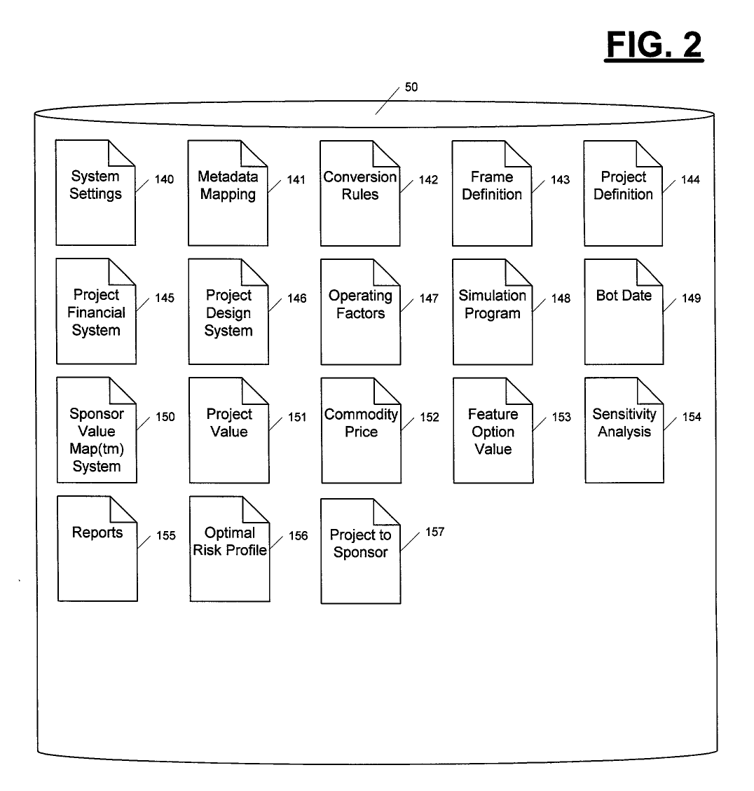

All extracted information concerning the project is stored in a file or table (hereinafter, table) within an application database (50) as shown in FIG. 2. The application database (50) contains tables for storing user input, extracted information and system calculations including a system settings table (140), a metadata mapping table (141), a conversion rules table (142), a frame definition table (143), a project definition table (144), a project financial system table (145), a project design system table (146), an operating factors table (147), a simulation program table (148), a bot date table (149), a Sponsor Value Map™ System table (150), a project value table (151), a commodity price table (152), a feature option value table (153), a sensitivity analysis table (154), a reports table (155), an optimal risk profile table (156) and a project to sponsor table (157). The application database (50) can optionally exist as a datamart, data warehouse, departmental warehouse or storage area network. The system of the present invention has the ability to accept and store supplemental or primary data directly from user input, a data warehouse or other electronic files in addition to receiving data from the databases described previously. The system of the present invention also has the ability to complete the necessary calculations without receiving data from one or more of the specified databases. However, in the preferred embodiment all required information is obtained from the specified databases (10, 15, 30, 35 & 45) and the Internet (40).

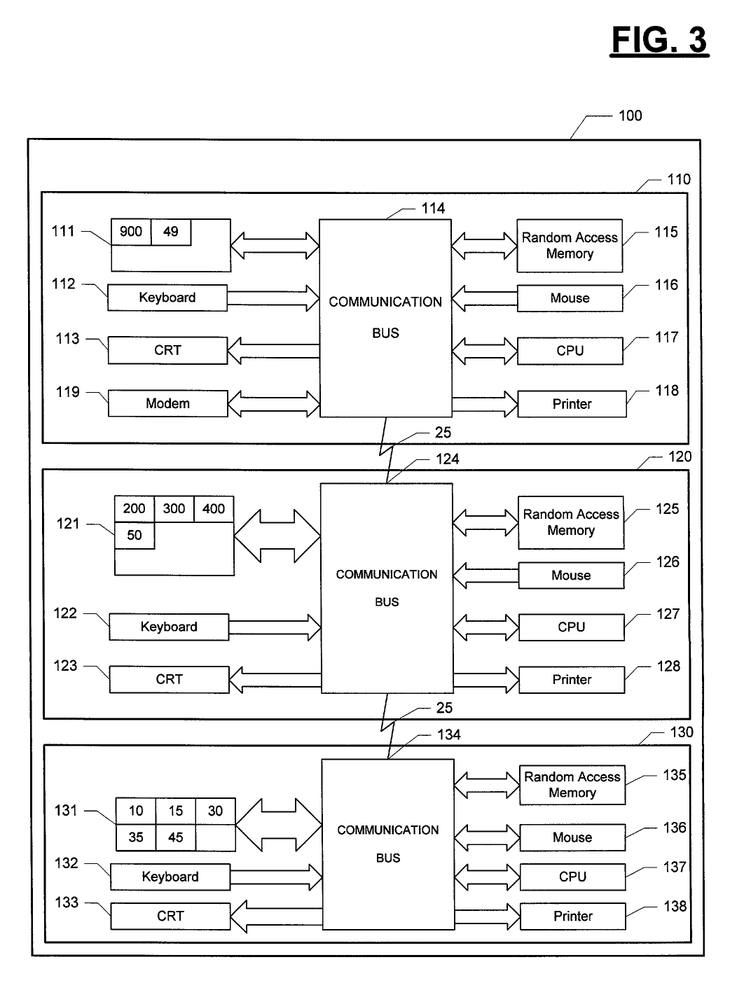

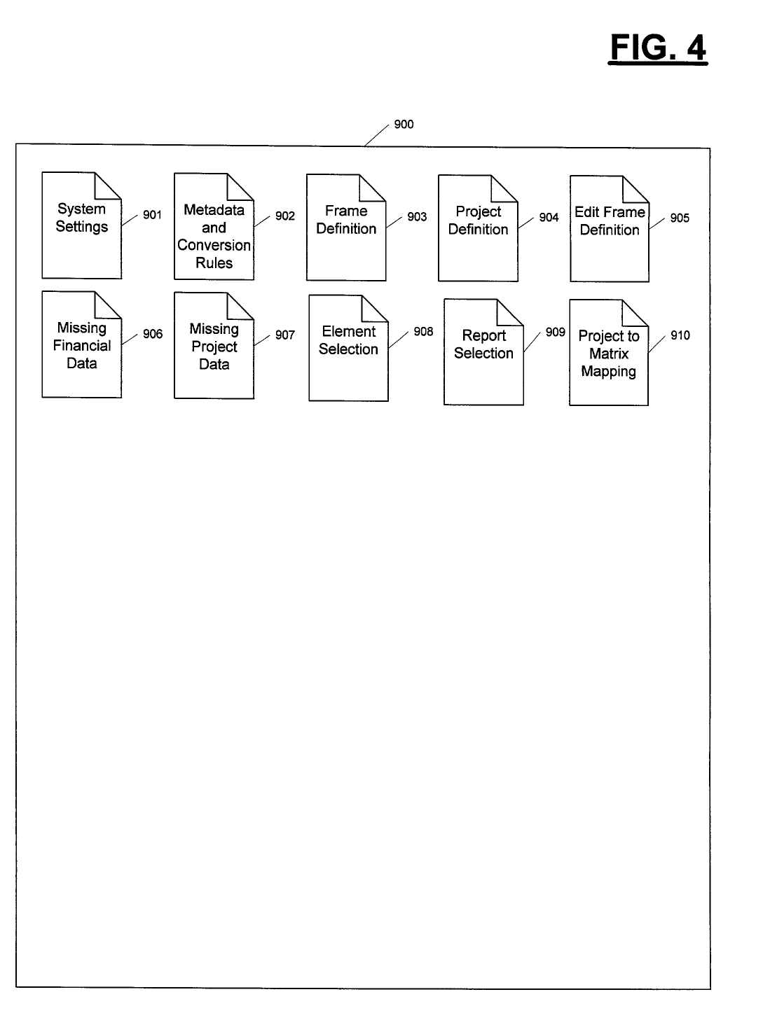

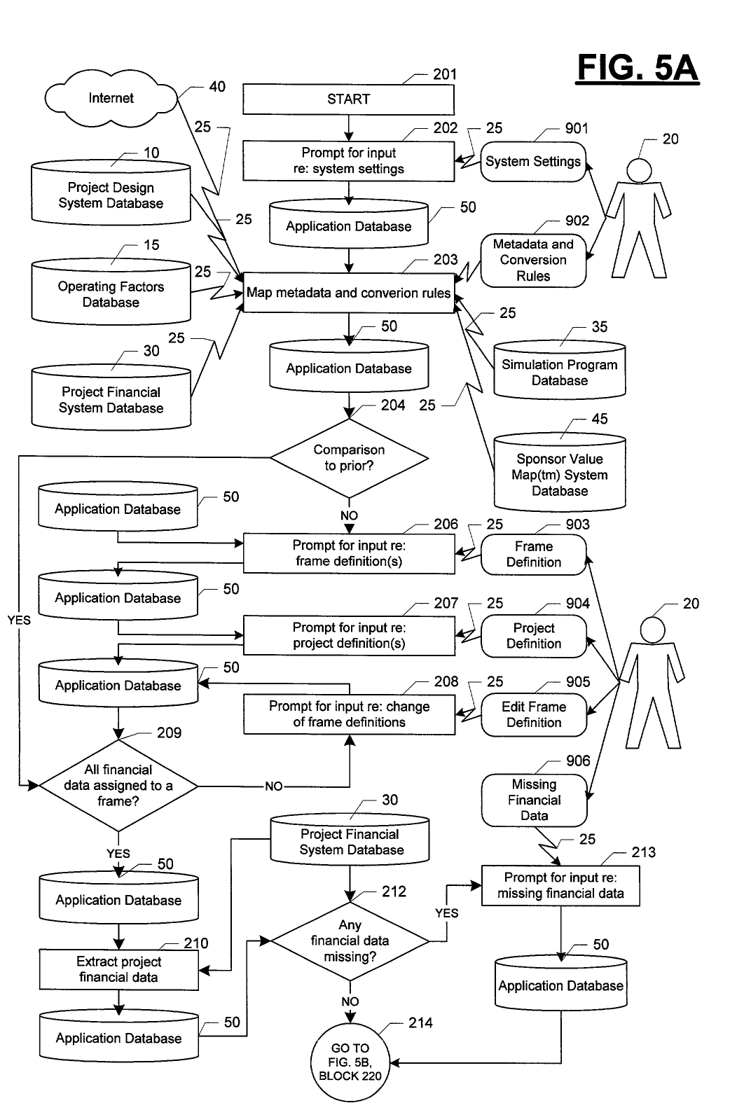

As shown in FIG. 3, the preferred embodiment of the present invention is a computer system (100) illustratively comprised of a client personal computer (110) connected to an application server personal computer (120) via a network (25). The application server personal computer (120) is in turn connected via the network (25) to a database-server personal computer (130).

The database-server personal computer (130) has, a hard drive (131) for storage of the design system database (10), operating factors database (15), project financial system database (30), optionally, the simulation program database (35), and the Sponsor Value Map® System database (45), a keyboard (132), a CRT display (133), a communications bus (134) and a read/write random access memory (135), a mouse (136), a CPU (137), and a printer (138).

The application-server personal computer (120) has a hard drive (121) for storage of the application database (50) and the majority of the application software (200, 300 and 400) of the present invention, a keyboard (122), a CRT display (123), a communications bus (124), and a read/write random access memory (125), a mouse (126), a CPU (127), and a printer (128). While only one client personal computer is shown in FIG. 3, it is to be understood that the application-server personal computer (120) can be networked to fifty or more client personal computers (110) via the network (25). The application-server personal computer (120) can also be networked to fifty or more server, personal computers (130) via the network (25). It is to be understood that the diagram of FIG. 3 is merely illustrative of one embodiment of the present invention.

The client personal computer (110) has a hard drive (111) for storage of a client data-base (49) and the user-interface portion of the application software (900), a keyboard (112), a CRT display (113), a communication bus (114), a read/write random access memory (115), a mouse (116), a CPU (117), a printer (118) and a modem (119).

The application software (200, 300 and 400) controls the performance of the central processing unit (127) as it completes the calculations required for project risk and return management. In the embodiment illustrated herein, the application software program (200, 300 and 400) is written in Java. The application software (200, 300 and 400) also uses Structured Query Language (SQL) for extracting data from other databases (10, 15, 30, 35 and 45) and then storing the data in the application database (50) or for receiving input from the user (20) and storing it in the client database (49). The other databases contain information regarding project design (10), project operating factors (15), project financials (30), project simulations, and the soft assets of the commercial enterprise with the project (45) that are used in the operation of the system (100). The user (20) provides the information the application software requires to determine which data need to be extracted and transferred from the database-server hard drive (131) via the network (25) to the application-server computer hard drive (121) by interacting with user-interface portion of the application software (900). The extracted information is combined with input received from the keyboard (113) or mouse (116) in response to prompts from the user-interface portion of the application software (900) before processing is completed.

User input is initially saved to the client database (49) before being transmitted to the communication bus (125) and on to the hard drive (122) of the application-server computer via the network (25). Following the program instructions of the application software, the central processing unit (127) accesses the extracted data and user input by retrieving it from the hard drive (122) using the random access memory (121) as computation workspace in a manner that is well known.

The computers (110, 120 and 130) shown in FIG. 3 illustratively are personal computers or any of the more powerful computers or workstations that are widely available. Typical memory configurations for client personal computers (110) used with the present invention should include at least 128 megabytes of semiconductor random access memory (115) and at least a 2-gigabyte hard drive (111). Typical memory configurations for the application-server personal computer (120) used with the present invention should include at least 256 megabytes of semiconductor random access memory (125) and at least a 250 gigabyte hard drive (121). Typical memory configurations for the database-server personal computer (130) used with the present invention should include at least 1024 megabytes of semiconductor random access memory (135) and at least a 500 gigabyte hard drive (131).

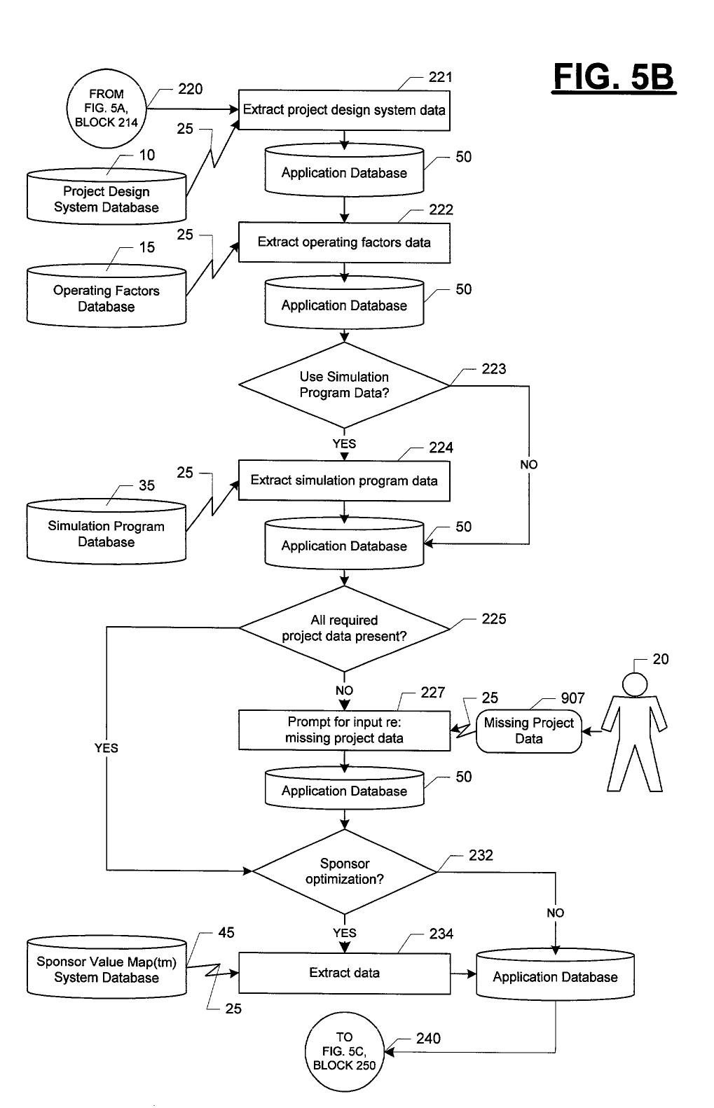

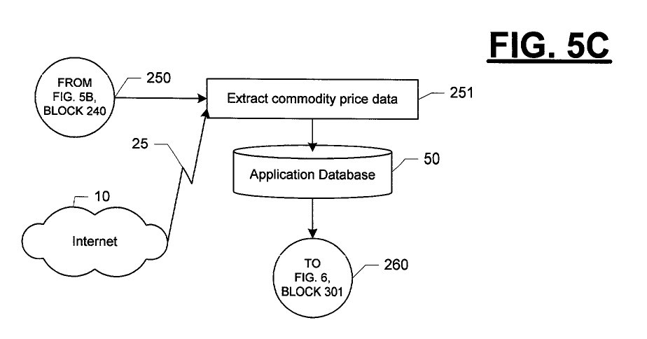

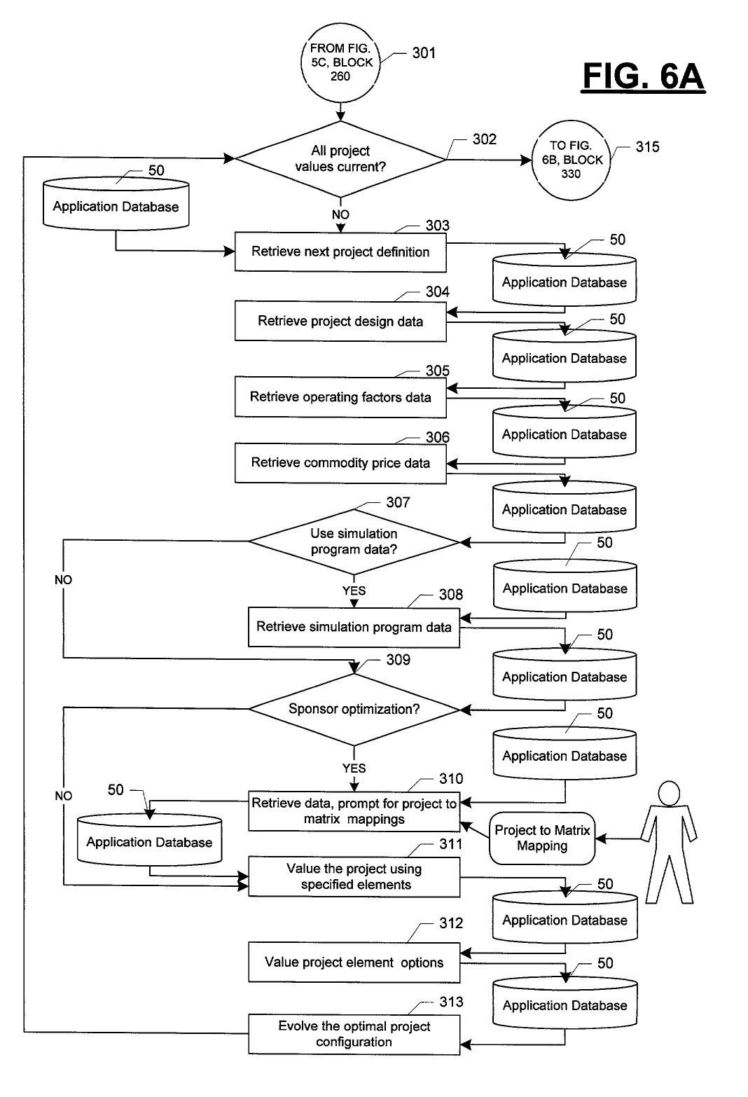

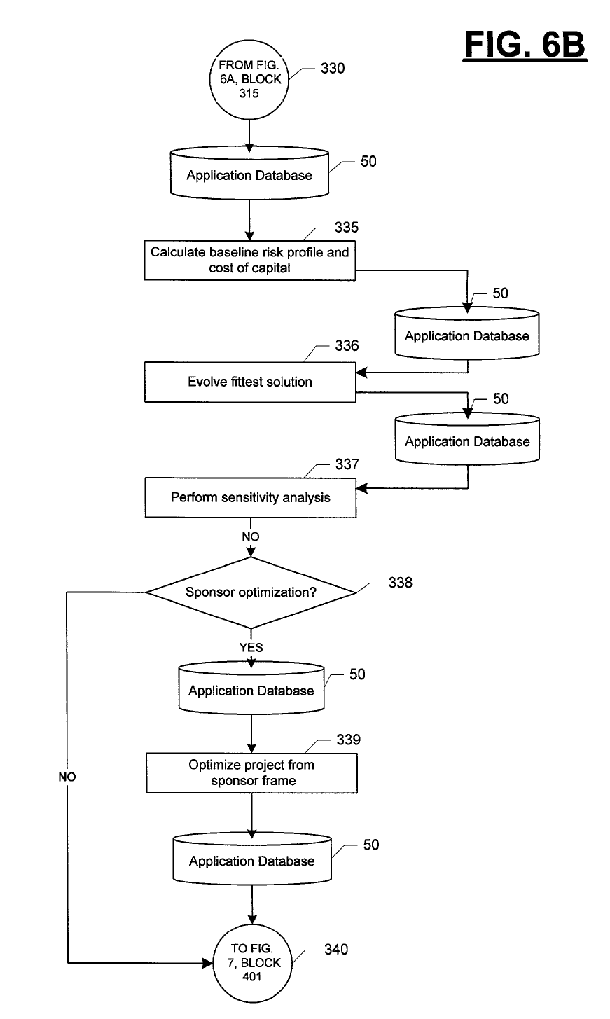

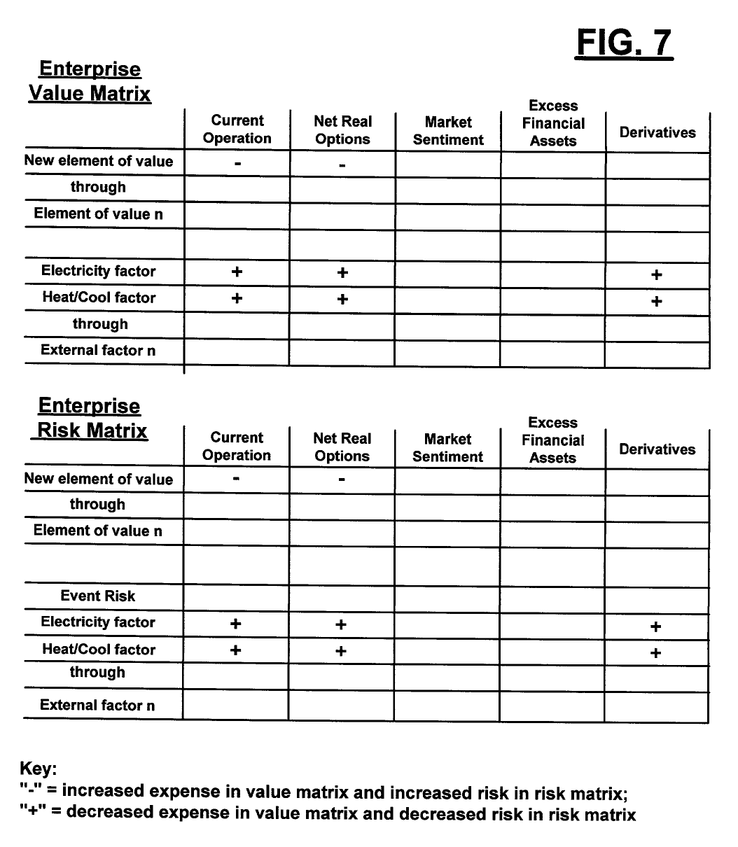

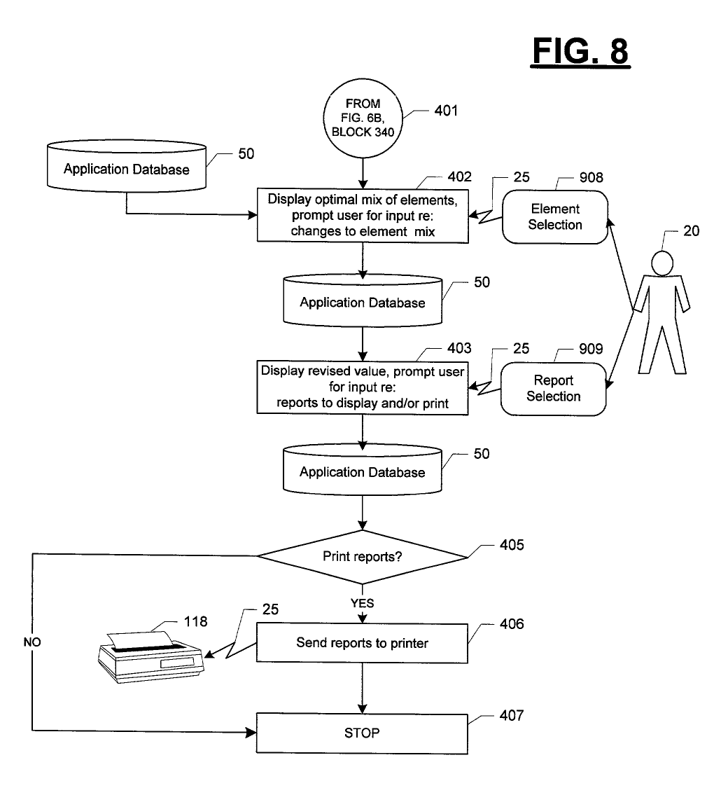

Using the system described above, the risk and return of the project being analyzed will be optimized from the perspective of the project sponsor. Optimizing the risk and return of a project as outlined previously is completed in three distinct stages. The first stage of processing (block 200 from FIG. 1) extracts, aggregates and stores the data from user input, internal databases (10, 15, 30, 35 or 45) and the internet (40) as required for the calculation of enterprise business value as shown in FIG. 5A, FIG. 5B and FIG. 5C. The second stage of processing (block 300 from FIG. 1) analyzes the required data and determines the mix of project features and feature options that maximizes project value while minimizing project risk as shown in FIG. 6A and FIG. 6B. The third and final stage of processing (block 400 from FIG. 1) displays the results of the prior calculations, optionally displays detailed graphical reports and optionally prints management reports as shown in FIG. 8.

### Data Extraction and Storage

The flow diagrams in FIG. 5A, FIG. 5B and FIG. 5C detail the processing that is completed by the portion of the application software (200) that extracts, aggregates and stores the information required for system operation from: a design system database (10), an operating factors database (15), a project financial system database (30), optionally, a simulation program database (35), the Internet (40) and a Sponsor Value Map® System database (45) and the user (20). A brief overview of the different databases will be presented before reviewing each step of processing completed by this portion (200) of the application software.

The systems used for managing project design and development are generally divided into two categories, computer automated design systems and project management systems (hereinafter, collectively referred to as project design systems). Architects, engineers and designers use computer aided design systems like AutoCAD, Solidworks, Mechcad, Ironcad, Orcad, Encad and Hyperplot are used to design and specify the project. Project management systems like Microsoft Project and Primavera are used track the use of project resources and the timing of project milestone completion. The data on the design and timing of the project from the databases of the computer aided design systems (as defined) is used as input to the system of the present invention to define the project or projects being analyzed.

The information from the project design systems is supplemented by data from the operating factors database and optionally a simulation program database. The operating factors database includes information concerning the cost, output impacts, size, weight, composition, risk mitigation and commodity consumption of each feature specified by the computer aided design system. Depending on the type of project, the feature information may be supplemented by information from real estate appraisal systems like HNC's that estimate the value of including specific features within a building. Simulation programs such as Blast, COMBINE, DOE-2, SPICE, etc. can be used to supplement or replace the operating factors data by calculating overall commodity consumption for the project and/or by forecasting project performance. The information regarding project design and operating performance is combined with commodity price information downloaded from web sites and/or databases on the internet (40) as required to support risk and return management for the project being analyzed. The information on commodity prices will include both current prices and future prices.

The sponsor Value Map™ System database (45) for an enterprise contains the same information as the xml summary database detailed in the cross referenced application Ser. No. 09/994,720 dated Nov. 28, 2001 and for a multi-enterprise organization it is the summary database detailed in cross-referenced application Ser. No. 09/994,739.

System processing of the information from the different databases (10, 15, 30, 35 and 45) and the Internet (40) described above starts in a block 201, FIG. 5A, which immediately passes processing to a software block 202. The software in block 202 prompts the user (20) via the system settings data window (901) to provide system settings information. The system settings information entered by the user (20) is transmitted via the network (45) back to the application server (120) where it is stored in the system settings table (140) in the application database (50) in a manner that is well known. The specific inputs the user (20) is asked to provide at this point in processing are shown in Table 2.

TABLE 2

| | |
|---|---|
| 1. | New run or comparison to prior? |
| 2. | Project sponsor |
| 3. | Project frame hierarchy (note: it is possible to have only |
| | one frame) |
| 4. | Operating factors |
| 5. | Risk factors |
| 6. | Risk factor weightings |
| 7. | Standard insurance rate for project |
| 8. | Metadata standard (XML, MS OIM, MDC) |
| 9. | Location of design system database and metadata |
| 10. | Location of operating factors database and metadata |
| 11. | Location of project financial database and metadata |
| 12. | Location of operation management system database and |
| | metadata |
| 13. | Location of simulation system databases and metadata |
| 14. | Location of external database and metadata |
| 15. | Location of Sponsor Value Map ® System database and |
| | metadata |
| 16. | Location of account structure |
| 17. | Base currency |
| 18. | Risk free cost of capital |
| 19. | Risk adjusted cost of capital |
| 20. | Management report types (text, graphic, both) |
| 21. | Default reports |
| 22. | Default missing data procedure |
| 23. | Maximum time to wait for user input |
| 24. | Maximum number of generations to process without |
| | improving fitness |

After the storage of system settings data is complete, processing advances to a software block 203. The software in block 203 prompts the user (20) via the metadata and conversion rules window (902) to map all relevant metadata using the standard specified by the user (20) from the design system database (10), operating factors database (15), a project financial system database (30), optionally, a simulation program database (35), the Internet (40) and a Sponsor Value Map® System database (45) to the project frame hierarchy stored in the system settings table (140). The metadata mapping specifications are saved in the metadata mapping table (141).

As part of the metadata mapping process, any database fields that are not mapped to the project frame hierarchy are defined by the user (20) as operating factors or non-relevant attributes. This information is also saved in the metadata mapping table (141). After all fields have been mapped to the metadata mapping table (141), the software in block 203 prompts the user (20) via the metadata and conversion rules window (902) to provide conversion rules for each metadata field for each data source. Conversion rules will include information regarding currency conversions and conversion for units of measure that may be required to consistently analyze the data. The inputs from the user (20) regarding conversion rules are stored in the conversion rules table (142) in the application database (50). When conversion rules have been stored for all fields from every data source, then processing advances to a software block 204.

The software in block 204 checks the system settings table (140) in the application database (50) to determine if the current calculation is a new calculation or a comparison to a prior calculation. If the calculation is a comparison to a prior calculation, then processing advances to a software block 209. Alternatively, if the calculation is not a comparison to a prior calculation, then processing advances to a software block 206.

The software in block 206 prompts the user (20) via the frame definition window (903) to define each of the frames for the frame hierarchy stored in the system settings table (140). It is worth noting here that there are generally at least two frames—the project sponsor frame and the stand-alone frame—for each project. The frame definition(s) include a brief description of the project, the frame time span and the design system features included in the frame. The specification of each frame is stored in the frame definition table (143) in the application database (50) before processing advances to a software block 207.

The software in block 207 prompts the user (20) via the project definition window (904) to define each of the projects that will be analyzed by the innovative system of the present invention. The project definition(s) include a brief description of the project, the project time frame, the expected project outputs and the design system features included in the project. The specification of each project is stored in the project definition table (144) in the application database (50) before processing advances to a software block 209.

The software in block 209 compares the project design and financial information stored in the metadata mapping table (141) with the frame definitions (142) to see if all project design and financial data is assigned to a frame. If all project design and financial data has been assigned to a frame, then processing advances to a software block 210. Alternatively, if all project design and financial data has not been assigned to a frame, then processing advances to a software block 208.

The software in block 208 prompts the user (20) via the edit frame definition window (905) to redefine frames as required to include all project design and financial data displayed on the window. The revised specification of each frame is stored in the frame definition table (143) in the application database (50) before processing returns to block 209. As described previously, if all project design and financial data has been assigned to a frame, then processing advances to a software block 210.

The software in block 210 checks the bot date table (149) and deactivates any project financial system data bots with creation dates before the current system date and retrieves information from the system settings table (140), metadata mapping table (141) and conversion rules table (142). The software in block 210 then initializes data bots by project for each field in the metadata mapping table (141) that mapped to the project financial system database (30). Bots are independent components of the application that have specific tasks to perform. In the case of data acquisition bots, their tasks are to extract and convert data from a specified source and then store it in a specified location. Each data bot initialized by software block 210 will store its data in the project financial system table (145). Every project financial system data bot contains the information shown in Table 3.

TABLE 3

| | |
|---|---|
| 1. | Unique ID number (based on date, hour, minute, second of creation) |
| 2. | The data source location |
| 3. | Mapping information |
| 4. | Timing of extraction |
| 5. | Sponsor |
| 6. | Project |
| 7. | Conversion rules (if any) |
| 8. | Storage location (to allow for tracking of source and destination |
| | events) |
| 9. | Creation date (date, hour, minute, second) |

After the software in block 210 initializes the bots for every mapped field within the project financial system database (30) by project and sponsor, the bots extract and convert data in accordance with their preprogrammed instructions. After the extracted and converted data is stored in the project financial system table (145), processing advances to a software block 212.

The software in block 212 compares the data in the project definition table (144) and the project financial system table (145) to determine if there are any periods where required financial data is missing for any project. If financial data are missing for any project, then processing advances to a software block 213. Alternatively, if the required financial data are present for every project for every time period, then processing advances to a software block 221.

The software in block 213 prompts the user (20) via the missing financial data window (906) to input missing financial data displayed on the window by project and sponsor. The new financial information supplied by the user (20) is stored in the project financial system table (145) before process advances to software block 221.

The software in block 221 checks the bot date table (149) and deactivates any project design system data bots with creation dates before the current system date and retrieves information from the system settings table (140), metadata mapping table (141) and conversion rules table (142). The software in block 221 then initializes data bots by project and sponsor for each field in the metadata mapping table (141) that mapped to the project design system database (10). Bots are independent components of the application that have specific tasks to perform. In the case of data acquisition bots, their tasks are to extract and convert data from a specified source and then store it in a specified location. Each data bot initialized by software block 221 will store its data in the project design system table (146). Every project design system data bot contains the information shown in Table 4.

TABLE 4

| | |
|---|---|
| 1. | Unique ID number (based on date, hour, minute, second of creation) |
| 2. | The data source location |
| 3. | Mapping information |
| 4. | Timing of extraction |
| 5. | Sponsor |
| 6. | Project |
| 7. | Field Description |
| 8. | Conversion rules (if any) |
| 9. | Storage location (to allow for tracking of source and destination |
| | events) |
| 10. | Creation date (date, hour, minute, second) |

After the software in block 221 initializes the bots for every mapped feature within the project design system database (10) by project and sponsor, the bots extract and convert data in accordance with their preprogrammed instructions. After the extracted and converted data is stored in the project design system table (146), processing advances to a software block 222.

The software in block 222 checks the bot date table (149) and deactivates any operating factor data bots with creation dates before the current system date and retrieves information from the system settings table (140), metadata mapping table (141) and conversion rules table (142). The software in block 222 then initializes data bots by project and sponsor for each field in the metadata mapping table (141) that mapped to the operating factors database (15). Bots are independent components of the application that have specific tasks to perform. In the case of data bots, their tasks are to extract and convert data from a specified source and then store it in a specified location. Each data bot initialized by software block 222 will store its data in the operating factors table (147). Every operating factor data bot contains the information shown in Table 5.

TABLE 5

| | |
|---|---|
| 1. | Unique ID number (based on date, hour, minute, second of creation) |
| 2. | The data source location |
| 3. | Mapping information |
| 4. | Timing of extraction |
| 5. | Sponsor |
| 6. | Project |
| 7. | Operating Factor |
| 8. | Conversion rules (if any) |
| 9. | Storage location (to allow for tracking of source and destination |
| | events) |
| 10. | Creation date (date, hour, minute, second) |

After the software in block 222 initializes the bots for every mapped factor within the operating factors database (15) by project and sponsor, the bots extract and convert data in accordance with their preprogrammed instructions. After the extracted and converted data is stored in the operating factors table (147), processing advances to a software block 223.

The software in block 223 checks the system settings table (140) to determine if simulation program data is being used in the project analysis. If simulation program data is being used, then processing advances to a software block 224. Alternatively, if simulation program data is not being used, then processing advances to a software block 225.

The software in block 224 checks the bot date table (149) and deactivates any simulation program data bots with creation dates before the current system date and retrieves information from the system settings table (140), metadata mapping table (141) and conversion rules table (142). The software in block 224 then initializes data bots by project and sponsor for each field in the metadata mapping table (141) that mapped to a field in the simulation programs database (35). Bots are independent components of the application that have specific tasks to perform. In the case of data bots, their tasks are to extract and convert data from a specified source and then store it in a specified location. Each data bot initialized by software block 224 will store its data in the simulation programs table (148). Every simulation program data bot contains the information shown in Table 6.

TABLE 6

| | |
|---|---|
| 1. | Unique ID number (based on date, hour, minute, second of creation) |
| 2. | The data source location |
| 3. | Mapping information |
| 4. | Timing of extraction |
| 5. | Sponsor |
| 6. | Project |
| 7. | Simulation result |
| 8. | Conversion rules (if any) |
| 9. | Storage location (to allow for tracking of source and destination |
| | events) |
| 10. | Creation date (date, hour, minute, second) |

After the software in block 224 initializes the bots for every mapped result within the simulation programs database (35) by project and sponsor, the bots extract and convert data in accordance with their preprogrammed instructions. After the extracted and converted data is stored in the simulation programs table (148), processing advances to a software block 225.

The software in block 225 compares the data in the project definition table (144) and the project design system table (146) and operating factors table (147) to determine if there any periods where required data is missing for any project. If data is missing for any project, then processing advances to a software block 227. Alternatively, if the required data is present for every project for every time period, then processing advances to a software block 232.

The software in block 227 prompts the user (20) via the missing project data window (907) to input missing project data displayed on the window. The new information supplied by the user (20) is stored in the project design system table (146) or operating factors table (147) before processing advances to software block 232.

The software in block 232 checks the system settings table (140) to determine if a sponsor frame optimization is being completed. If a sponsor frame optimization is being calculated, then processing advances to a software block 228. Alternatively, if a sponsor frame optimization is not being analyzed, then processing advances to a software block 251.

The software in block 228 checks the bot date table (149) and deactivates any Sponsor Value Map® System data bots with creation dates before the current system date and retrieves information from the system settings table (140), metadata mapping table (141) and conversion rules table (142). The software in block 228 then initializes data bots by project and sponsor for each field in the metadata mapping table (141) that mapped to a value driver in the Sponsor Value Map® Systems database (35). Bots are independent components of the application that have specific tasks to perform. In the case of Sponsor Value Map® System data bots, their tasks are to extract and convert data detailing the matrices of value and risk for the specified sponsor from a specified source and store the information in a specified location. Each data bot initialized by software block 228 will store its data in the Sponsor Value Map® Systems table (150). Every Sponsor Value Map® System data bot contains the information shown in Table 7.

TABLE 7

| | |
|---|---|
| 1. | Unique ID number (based on date, hour, minute, second of creation) |
| 2. | The data source location |
| 3. | Mapping information |
| 4. | Timing of extraction |
| 5. | Sponsor |
| 6. | Project |
| 7. | Segment of value, element of value or external factor |
| 8. | Conversion rules (if any) |
| 9. | Storage location (to allow for tracking of source and destination |
| | events) |
| 10. | Creation date (date, hour, minute, second) |

After the software in block 228 initializes the bots for every mapped value driver within the Sponsor Value Map® Systems database (45) by project and sponsor, the bots extract and convert data in accordance with their preprogrammed instructions. After the extracted and converted data is stored in the Sponsor Value Map Systems table (150), processing advances to a software block 251.

The software in block 251 checks the bot date table (149) and deactivates any commodity price data bots with creation dates before the current system date and retrieves information from the system settings table (140), metadata mapping table (141) and conversion rules table (142). The software in block 251 then initializes data bots by commodity for each field in the metadata mapping table (141) that mapped to a commodity price on the Internet (40). Bots are independent components of the application that have specific tasks to perform. In the case of data bots, their tasks are to extract and convert data from a specified source for the time period and then store it in a specified location. Each data bot initialized by software block 251 will store the data it retrieves in the commodity price table (150). Every commodity price data bot contains the information shown in Table 8.

TABLE 8

| | |
|---|---|
| 1. | Unique ID number (based on date, hour, minute, second of creation) |
| 2. | The data source location |
| 3. | Mapping information |
| 4. | Timing of extraction |
| 5. | Sponsor |
| 6. | Project |
| 7. | Commodity |
| 8. | Time period(s) |
| 9. | Conversion rules (if any) |
| 10. | Storage location (to allow for tracking of source and destination |
| | events) |
| 11. | Creation date (date, hour, minute, second) |

After the software in block 228 initializes the bots for every mapped commodity on the Internet (40), the bots extract and convert data in accordance with their preprogrammed instructions. After the extracted and converted data is stored in the commodity price table (150), processing advances to a software block 302.

### Analysis

The flow diagrams in FIG. 6A and FIG. 6B detail the processing that is completed by the portion of the application software (300) that programs analysis bots to:
1. Value the project with the baseline set of features;
2. Value options to add, replace or modify project features (feature options);
3. Determine the mix of project features and options that maximize value;
4. Evaluate the baseline project risk profile;
5. Determine the mix of project features and feature options that maximizes value while minimizing risk from the specified frames; and
6. Evaluate the sensitivity of the optimal solution to changing operating factors.

Each analysis bot generally normalizes the data being analyzed before processing begins.

Processing in this portion of the application begins in software block 302. The software in block 302 checks the system settings table (140) in the application database (50) to determine if the current calculation is a new calculation or a comparison to a prior calculation. The software in block 302 also compares the date in the frame definition table (143), project definition table (144) and the project value table (151) to determine if there are current valuations for all projects. A valuation is said to be “current” if it has been completed within the time frame specified by the user (20) in the system settings table (140). If there are current valuations for all projects and frames, then processing advances to a software block 331. Alternatively, if there are projects that don't have current valuations for all frames, then processing advances to a software block 303.

The software in block 303 retrieves data from the frame definition table (143), project definition table (144) and the project value table (151) as required to identify the next project that does not have a current valuation. After identifying the next project without a current valuation for all frames, the software in block retrieves the complete definition of that project and the frames that are associated with it from the project definition table (144) and the frame definition table (143) before processing advances to a software block 304. The software in block 304 retrieves the project design data for the project being analyzed from the project design system table (146) before processing advances to a software block 305. The software in block 305 retrieves the operating factors for the project being analyzed from the operating factors table (147) before processing advances to a software block 306. The software in block 306 retrieves the commodity prices for the project being analyzed from the commodity price table (152) before processing advances to a software block 307.

The software in block 307 checks the system settings table (140) to determine if simulation program data is being used in the project analysis. If simulation program data is being used, then processing advances to a software block 308. Alternatively, if simulation program data is not being used, then processing advances to a software block 309.

The software in block 308 retrieves the operating factors for the project being analyzed from the simulation program table (148) before processing advances to software block 309.

The software in block 309 checks the system settings table (140) to determine if a sponsor frame optimization is being completed. If a sponsor frame optimization is being calculated, then processing advances to a software block 310. Alternatively, if a sponsor frame optimization is not being analyzed, then processing advances to a software block 311.

The software in block 310 retrieves the matrix of value and matrix of risk information for the project sponsor for the project being analyzed from the Sponsor Value Map® System table (151) before it prompts the user (20) via the project to matrix mapping window (910) to specify the links between project outputs and the matrices of value and risk for the sponsor. The resulting linkage information is saved in the project to sponsor link table (157) by project before processing advances to software block 311.

The software in block 311 checks the bot date table (149) and deactivates any project valuation bots with creation dates before the current system date and retrieves information from the system settings table (140), metadata mapping table (141), the conversion rules table (142), the frame definition table (143), the project definition table (144), the project financial system table (145), the project design system table (146), the operating factors table (147) and the simulation program table (148) if data from there is being used. The software in block 311 then initializes project valuation bots by frame for the project being analyzed. Bots are independent components of the application that have specific tasks to perform. In the case of project valuation bots, their primary tasks are to calculate the cash flow for the project for every time period where data is available. Cash flow is calculated using a well-known formula where cash flow equals period income minus period expense plus the period change in capital plus non-cash depreciation/amortization for the period. Period income and expenses are calculated by combining the information regarding project design with the operating factor, project financial and simulation data regarding The calculated cash flow is then discounted by the baseline cost of capital specified by the user (20) in the system settings table (140) to calculate the baseline value of the project by frame. The software in block 311 generates project valuation bots for every frame associated with the project being analyzed.

Every cash flow bot contains the information shown in Table 9.

TABLE 9

| | |
|---|---|
| 1. | Unique ID number (based on date, hour, minute, second of creation) |
| 2. | Creation date (day, hour, minute, second) |
| 3. | Mapping information |
| 4. | Storage location |
| 5. | Sponsor |
| 6. | Project |
| 7. | Project frame |
| 8. | Time frame |

After the software in block 311 initializes the project valuation bots, the bots activate in accordance with their preprogrammed instructions. After being activated, the bots complete the calculation of baseline project value by frame and save the resulting values in the project value table (151) in the application database (50) before processing advances to a software block 312.

The software in block 312 checks the bot date table (149) and deactivates any feature option bots with creation dates before the current system date and retrieves information from the system settings table (140), metadata mapping table (141), the conversion rules table (142), the frame definition table (143), the project definition table (144), the project financial system table (145), the project design system table (146), the operating factors table (147) and the simulation program table (148) if data from there is being used. The software in block 312 then initializes feature option bots by feature for the project being analyzed by frame. Feature option bots calculate the value the option to add a feature or remove a baseline feature by project and sponsor frame. For example, the value of the option to add piping that would facilitate a retrofit to an alternate source of water supply at a later date could be valued. The value of the real option to add or remove each feature is calculated using Black Scholes algorithms and the baseline discount rate in a manner that is well known. The real option can be valued using other algorithms including binomial, Quadranomial, neural network or dynamic programming algorithms. Feature option bots contain the information shown in Table 10.

TABLE 10

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Sponsor |
| 6. | Project |
| 7. | Project Feature |
| 8. | Frame |
| 9. | Baseline feature? (Y or N) |

After the feature option bots are initialized, the bots activate in accordance with their preprogrammed instructions. After being activated, the bots complete the calculation of feature option values and save the resulting values in the feature option value table (153) in the application database (50) before processing advances to a software block 313.

The software in block 313 checks the bot date table (149) and deactivates any optimization bots with creation dates before the current system date and retrieves information from the system settings table (140), metadata mapping table (141), the conversion rules table (142), the frame definition table (143), the project definition table (144), the project financial system table (145), the project design system table (146), the operating factors table (147) and the simulation program table (148) if data from there is being used. Bots are independent components of the application that have specific tasks to perform. In the case of optimization bots, their primary task is to determine the optimal mix of features and feature options for the project on a stand-alone basis by frame. The optimization bots run simulations of project financial performance and valuation using an unconstrained genetic algorithm that evolves to the most valuable scenario. Other optimization algorithms, including those with constraints can be used to the same effect however, in the preferred embodiment genetic algorithms are used. The standard insurance rate stored in the system settings table (140) is used for all simulations. Every optimization bot activated in this block contains the information shown in Table 11.

TABLE 11

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Sponsor |
| 6. | Project. |
| 7. | Frame |

After the optimization bots are initialized, the bots activate in accordance with their preprogrammed instructions. After being activated, the bots determine the mix of features and feature options that maximize the value of the project for each frame. The optimal mix is saved in the project definition table (144) in the application database (50) by frame before processing advances to a software block 335.

The software in block 335 checks the bot date table (149) and deactivates any risk profile bots with creation dates before the current system date. The software in the block then retrieves information from the system settings table (140), metadata mapping table (141), the conversion rules table (142), the frame definition table (143) and the project definition table (144) as required to initialize the bots. Bots are independent components of the application that have specific tasks to perform. In the case of risk profile bots, their primary task is to determine the level of risk associated with the optimal mix of features and feature options for the project by frame. The risk profile bots examine the impact of the optimal mix of features and feature options on the project risk factors stored in the system settings table (140) and calculates the risk adjusted cost of capital for the project and the risk adjusted insurance rate for the project. Every risk profile bot activated in this block contains the information shown in Table 12.

TABLE 12

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Sponsor |
| 6. | Project. |
| 7. | Frame |

After the risk profile bots are initialized, the bots activate in accordance with their preprogrammed instructions. After being activated, the bots determine the risk adjusted cost of capital and the risk adjusted insurance rate by project for each frame. The resulting cost of capital and insurance rate are saved in the optimal risk profile table (156) in the application database (50) by frame before processing advances to a software block 336

The software in block 336 checks the bot date table (149) and deactivates any risk and return optimization bots with creation dates before the current system date. The software in the block then retrieves information from the system settings table (140), metadata mapping table (141), the conversion rules table (142), the frame definition table (143), the project definition table (144) and the optimal risk profile table (156) as required to initialize the bots. Bots are independent components of the application that have specific tasks to perform. In the case of risk and return optimization bots, their primary task is to determine the optimal mix of features and feature options for the project by frame. The optimization bots run simulations of project financial performance; project value and project risk using an unconstrained genetic algorithm that evolves to the most valuable mix of features and feature options. This optimization differs from the prior optimization in that the insurance cost and the cost of capital used to discount the expected cash flows change as the feature/feature option mix changes. Every risk and return optimization bot activated in this block contains the information shown in Table 13.

TABLE 13

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Sponsor |
| 6. | Project. |
| 7. | Frame |

After the risk and return optimization bots are initialized, the bots activate in accordance with their preprogrammed instructions. After being activated, the bots determine the mix of features and feature options that maximize project value while minimizing project risk for each frame. The optimal mix is saved in the project definition table (144) and the new optimal risk factor mix, risk adjusted cost of capital and risk adjusted insurance rate are saved in the optimal risk profile table (156) by frame before processing advances to a software block 337.

The software in block 337 checks the bot date table (149) and deactivates any sensitivity bots with creation dates before the current system date. The software in the block then retrieves information from the system settings table (140), metadata mapping table (141), the conversion rules table (142), the frame definition table (143), the project definition table (144), the project financial system table (145), the project design system table (146), the operating factors table (147), the simulation program table (148) if data from there is being used, the commodity price table (152) and the optimal risk profile table (156) as required to initialize the sensitivity bots. Bots are independent components of the application that have specific tasks to perform. In the case of sensitivity bots, their primary task is to determine the sensitivity of the optimal mix to changes in commodity, operating factor, capital, feature and feature option prices by frame. The sensitivity bots run simulations of project financial performance, project value and project risk using an unconstrained genetic algorithm that evolves to the most valuable scenario. Every sensitivity bot activated in this block contains the information shown in Table 14.

TABLE 14

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Factor: commodity, operating factor, feature or feature option |
| 6. | Sponsor |
| 7. | Project. |
| 8. | Frame |

After the sensitivity bots are initialized, the bots activate in accordance with their preprogrammed instructions. After being activated, the bots determine how project value and the mix of features and feature options that maximize project value and minimize risk change for each frame as the price for the factor being analyzed is changed. The results of this analysis are saved in the sensitivity analysis table (154) in the application database (50) by frame before processing advances to a software block 338.

The software in block 338 checks the system settings table (140) to determine if a sponsor frame optimization is being completed. If a sponsor frame optimization is being calculated, then processing advances to a software block 339. Alternatively, if a sponsor frame optimization is not being analyzed, then processing advances to a software block 402.

The software in block 339 retrieves data from the Sponsor Value Map® System table (150) and the project to sponsor table (157) as required to map the project features and feature options to the matrices of value and risk for the sponsor of the project. The software in block 339 uses the retrieved data to define and initialize an optimization model for the sponsor of the project that is being analyzed. The preferred embodiment of the optimization model is a genetic algorithm where changes are constrained to project features and feature options, however, other optimization algorithms can be used with similar results. After the optimization calculation is completed, the software in block 339 saves the optimal mix of features and feature options in the project definition table (144) and the value of the project to the sponsor given the optimal mix is saved in the project value table (151) before processing advances to software block 402. The same basic procedure can be used to identify the combination of projects that will add the most value to the sponsor.

### Reporting

The flow diagram in FIG. 8 details the processing that is completed by the portion of the application software (400) that creates, displays and optionally prints project management reports. If a comparison calculation has been completed, a report can be generated to highlight changes in project value from the prior analysis.

Processing in this portion of the application begins in software block 402. The software in block 402 displays the mix of project features and project options that maximize expected project value while minimizing project risk for the sponsor, the optimal mix for other frames can also be displayed at this time. The software in block 402 then prompts the user (20) via the feature selection window (908) to optionally edit the optimal mix that was displayed. Any input regarding a change to the optimal mix is saved in the project definition table (141) before processing advances to a software block 403. The users input regarding changes in the optimal mix could also be forwarded to a simulation program at this point to determine if the user (20) specified changes had any material affect on the commodity consumption by the project.

The software in block displays the revised project values by frame and prompts the user (20) via a report selection data window (909) to designate reports for creation, display and/or printing. One report the user (20) has the option of selecting at this point shows the value of each feature or feature option to the project and frame being analyzed. The report also summarizes the factors that led to the addition or exclusion of each feature or feature option of the project as shown in Table 15. When the analysis is a comparison to a prior analysis, the report will clearly show the impact of changing one or more features or feature options on project value and/or project risk.

TABLE 15

| | | |
|---|---|---|
| Economic factor | Impact | Rationale |

Category 1 - are features that are included in the optimal mix.
The feature is in the optimal mix because increased income;
decreased expenses and/or lower risk are sufficient to offset
the incremental cost of including the feature.
Example: installation of low emission materials.

| | | |
|---|---|---|
| Construction Costs | − | Increased cost for materials |
| Rent | + | Increased rent for more |
| | | productive environment |
| Operating Cost | + | Reduced insurance expense |
| | | from less environmental risk |
| Capital Cost | + | Lower interest rate from |
| | | reduced environmental risk |
| Net Impact - $201,988 | + | Adds value to project |

Category 2 - are features where providing the real option to
implement at a later date is included in the optimal mix.
The feature option is included in the optimal mix because
inflation, technology development and/or a longer investment
horizon for a subsequent owner are expected to make the
feature economically viable over the long term.
Example: option to install wastewater treatment

| | | |
|---|---|---|
| Construction Costs | − | Costly installation |
| Rent | NA | No impact forecast |
| Operating Cost | + | Water savings, expect to |
| | | increase over time with |
| | | inflation |
| Capital Cost | + | Lower interest rate from |
| | | reduced inflation risk |
| | | (water cost hedge) |
| Net Impact - $977,388 | −/+ | Not viable now/will be later |

Category 3 - features that are not included in the optimal mix.
The feature is not included in optimal mix because the increased
income, decreased expenses and/or lower risk generated by the
feature are not sufficient to offset the incremental cost of
including the feature in both the short term and the long term.
Example: vegetative roofs

| | | |
|---|---|---|
| Construction Costs | − | Increased cost of installation |
| Rent | NA | No impact forecast |
| Operating Cost | + | Storm water savings |
| Capital Cost | NA | No impact forecast |
| Net Impact - ($128,998) | − | Not viable |

Other reports graphically display the sensitivity of the optimal mix to changes in the different operating factors and commodity prices for the different frames. After the user (20) has completed the review of displayed reports and the input regarding reports to print has been saved in the reports table (155) processing advances to a software block 405.

The software in block 405 checks the reports tables (155) to determine if any reports have been designated for printing. If reports have been designated for printing, then processing advances to a block 406 where the software in the block prepares and sends the designated reports to the printer (118). After the reports have been sent to the printer (118), processing advances to a software block 407 where processing stops. Alternatively, if the software in block 405 determines that no additional reports have been designated for printing, then processing advances to block 407 where processing stops.

Thus, the reader will see that the system and method described above transforms extracted transaction data and information into a specification of the optimal mix of features and feature options for a project. The optimal mix is the mix that maximizes expected value while minimizing risk for the project sponsor. The level of detail contained in the project specification enables the analysis and simulation of the impact of changes in the identified project on the other the future value and risk of the enterprise that owns the project.

While the above description contains many specificities, these should not be construed as limitations on the scope of the invention, but rather as an exemplification of one preferred embodiment thereof. Accordingly, the scope of the invention should be determined not by the embodiment illustrated, but by the appended claims and their legal equivalents.

1. A computer readable medium having sequences of instructions stored therein, which when executed cause the processors in a plurality of computers that have been connected via a network to perform a project optimization method, comprising:
obtaining specifications for one or more projects and an organization ontology;
mapping the organization impact of specified project outputs using said ontology;
creating an organization optimization model using said impacts and ontology; and
simulating organization financial performance with said model to determine the optimal specification for the one or more projects.

2. The computer readable medium of claim 1 where the method further comprises identifying the optimal set of projects for the organization.

3. The computer readable medium of claim 1 where the project specification includes attributes from the group consisting of project budget, project design, project features, project operating factors, project outputs, the relationship between project features and the project budget and outputs and combinations thereof.

4. The computer readable medium of claim 3 where the project features encapsulate all the different options for completing the project including any options for implementing a project completion option at a future date.

5. The computer readable medium of claim 3 where the project budget includes project expenses and project capital requirements.

6. The computer readable medium of claim 1 where project specification data is obtained from the group consisting of design systems, project systems, simulation systems, basic financial system, advanced financial system, operating factor databases and combinations thereof.

7. The computer readable medium of claim 1 where the organization is a single product, a group of products, a division, a company, a multi-company corporation, a value chain, a government organization or a collaboration.

8. The computer readable medium of claim 7 where a collaboration is a joint effort between any combination of products, groups of products, divisions, companies, multi company corporations, value chains and government organizations.

9. The computer readable medium of claim 1 where an organization ontology comprises a common schema and the quantified inter-relationship between the elements, factors and risks that drive organization financial performance.

10. The computer readable medium of claim 9 where the elements are from the group consisting of alliances, brands, channels, customers, customer relationships, employees, equipment, knowledge, intellectual property, investors, partnerships, processes, products, quality, vendors, vendor relationships, visitors and combinations thereof.

11. The computer readable medium of claim 9 where the factors are from the group consisting of numerical indicators of conditions external to the organization, numerical indications of prices external to the organization, numerical indications of organization conditions compared to external expectations of organization condition, numerical indications of the organization performance compared to external expectations of organization performance and combinations thereof.

12. The computer readable medium of claim 9 where the risks are from the group consisting of contingent liabilities, event risks, variability risks, volatility and combinations thereof.

13. The computer readable medium of claim 9 where the common schema defines common attributes from the group consisting of data structure, organization designation, metadata standard and data dictionary.

14. The computer readable medium of claim 13 where the data dictionary defines standard data attributes from the group consisting of account numbers, components of value, currencies, elements of value, enterprise designations, external factors, organization designations, segments of value, risks, time periods, units of measure and combinations thereof.

15. The computer readable medium of claim 9 where the quantified inter-relationship between the elements, factors and risks is determined by segment of value and enterprise for aspects of organization financial performance.

16. The computer readable medium of claim 15 where the segments of value are from the group consisting of current operations, real options, derivatives, excess financial assets, market sentiment and combinations thereof.

17. The computer readable medium of claim 15 where an enterprise is a single product, a group of products, a division, a company or a government organization.

18. The computer readable medium of claim 15 where the aspects of organization financial performance are from the group consisting of revenue, expense, capital change, current operation returns, real option returns, derivative returns, excess financial asset returns, market sentiment returns, current operation risk, real option risk, derivative risk, excess financial asset risk, market sentiment risk, current operation value, real option value, derivative value, excess financial asset value, market sentiment value, organization returns, organization risk, organization value and combinations thereof.

19. The computer readable medium of claim 15 where the quantified interrelationship between elements, factors and aspects of financial performance is determined by a series of computations completed by algorithms from the group consisting of neural network; regression, generalized additive; support vector method, entropy minimization, generalized autoregressive conditional heteroskedasticity, wavelets, Markov, Bayesian, multivalent, multivariate adaptive regression splines, data envelopment analysis, path analysis and combinations thereof.

20. The computer readable medium of claim 13 where the metadata standard is an xml standard.

21. The computer readable medium of claim 1 where the optimization model is a multi-criteria optimization model or a single criteria optimization model.

22. The computer readable medium of claim 1 where optimal project specification is the specification that optimizes one or more aspects of organization financial performance from the group consisting of revenue, expense, capital change, current operation returns, real option returns, derivative returns, excess financial asset returns, market sentiment returns, current operation risk, real option risk, derivative risk, excess financial asset risk, market sentiment risk, current operation value, real option value, derivative value, excess financial asset value, market sentiment value, organization returns, organization risk and organization value.

23. The computer readable medium of claim 2 where optimal set of projects is the set that optimizes one or more aspects of organization financial performance from the group consisting of revenue, expense, capital change, current operation returns, real option returns, derivative returns, excess financial asset returns, market sentiment returns, current operation risk, real option risk, derivative risk, excess financial asset risk, market sentiment risk, current operation value, real option value, derivative value, excess financial asset value, market sentiment value, organization returns, organization risk and organization value.

24. The computer readable medium of claim 1 where simulations are completed using genetic algorithms or Monte Carlo simulations.

25. The computer readable medium of claim 2 where the method further comprises displaying the organization value, optimal project specifications, the optimal set of projects and combinations thereof using a paper document or electronic display.

26. A method for creating an organization value matrix that quantifies the contribution of elements of value to a value of an organization by segment of value and enterprise.

27. The method of claim 26 where the organization is a single product, a group of products, a division, a company, a multi-company corporation, a value chain, a government organization or a collaboration and a collaboration is a joint effort between any combination of products, groups of products, divisions, companies, multi company corporations, value chains and government organizations.

28. The method of claim 26 where the elements are from the group consisting of alliances, brands, buildings, cash, channels, customers, customer relationships, employees, employee relationships, equipment, knowledge, intellectual property, investors, inventory, partnerships, processes, products, quality, vendors, vendor relationships, visitors and combinations thereof.

29. The method of claim 26 where the segments of value are from the group consisting of current operations, real options, derivatives, excess financial assets, market sentiment and combinations thereof.

30. The method of claim 26 that also identifies the contribution of external factors to organization value by segment of value and enterprise where the external factors are from the group consisting of numerical indicators of conditions external to the organization, numerical indications of prices external to the organization, numerical indications of organization conditions compared to, external expectations of organization condition, numerical indications of the organization performance compared to external expectations of organization performance and combinations thereof.

31. An organization integration method, comprising:
developing an organization ontology, and
using said ontology to guide the integration of any combination of data, information and systems to support organization processing.

32. The method of claim 31 where an organization ontology comprises a common schema and the quantified inter-relationship between the elements, factors and risks that drive organization performance.

33. The method of claim 31 data are from the group consisting of: transaction data, descriptive data, geospatial data, text data, linkage data, semantic data and combinations thereof.

34. The method of claim 31 wherein systems are from the group consisting of: basic financial systems, advanced financial systems, web site management systems, operation management systems, supply chain management systems, risk management systems, customer relationship management systems, partner relationship management systems, channel management systems, knowledge management systems, visitor relationship management systems, intellectual property management systems, investor management systems, vendor management systems, alliance management systems, process management systems, brand management systems, workforce management systems, human resource management systems, email management systems, IT management systems, quality management systems, accounts receivable systems, accounts payable systems, capital asset systems, inventory systems, invoicing systems, payroll systems, purchasing systems, project management systems, design systems, simulation systems and combinations thereof.

35. A computer readable medium having sequences of instructions stored therein, which when executed cause the processor in a computer to perform an organization project method, comprising:
aggregating organization data in accordance with an xml schema,
using at least a portion of the data to create matrices of organization value and risk,
combining the quantified inter-relationship between the elements, factors and risks identified by the matrices of value and risk with the xml schema to form an ontology;
obtaining specifications for one or more projects,
mapping the organization impact of specified project outputs using said ontology,
creating an organization optimization model using said impacts and ontology; and
simulating organization financial performance with said model to determine the optimal specification for the one or more projects.
